(19) United States
(12) Patent Application Publication
(10) Pub. No.: US 2023/0053174 A1
(43) Pub. Date: Feb. 16, 2023

(54) DATA AMOUNT SUFFICIENCY DETERMINATION DEVICE, DATA AMOUNT SUFFICIENCY DETERMINATION METHOD, LEARNING MODEL GENERATION SYSTEM, TRAINED MODEL GENERATION METHOD, AND MEDIUM

(71) Applicant: Mitsubishi Electric Corporation, Tokyo (JP)

(72) Inventors: Takahiko MASUZAKI, Tokyo (JP); Osamu NASU, Tokyo (JP)

(73) Assignee: Mitsubishi Electric Corporation, Tokyo (JP)

(21) Appl. No.: 17/974,040

(22) Filed: Oct. 26, 2022

Related U.S. Application Data
(63) Continuation of application No. PCT/JP2020/025227, filed on Jun. 26, 2020.

(51) Int. Cl. G06N 20/00; G06N 7/00

(52) U.S. Cl. CPC G06N 20/00; G06N 7/005

(57) ABSTRACT

Provided is a data amount sufficiency determination device capable of determining the sufficiency of the data amount of learning data with higher accuracy.

A data amount sufficiency determination device according to the present disclosure includes a time series data acquisition unit to acquire time series data, a data division unit to divide the time series data into a plurality of pieces of substring data, a data set generation unit to generate a plurality of substring data sets that are sets of substring data, a feature amount calculation unit to calculate a feature amount of the substring data, a probability distribution generation unit to generate probability distribution of the feature amount for each substring data sets, and a determination unit to determine whether or not the probability distribution has converged.

### CROSS REFERENCE TO RELATED APPLICATION

This application is a Continuation of PCT International Application No. PCT/JP2020/025227, filed on Jun. 26, 2020, which is hereby expressly incorporated by reference into the present application.

### TECHNICAL FIELD

The present disclosure relates to a data amount sufficiency determination device, a data amount sufficiency determination method, a learning model generation system, a trained model generation method, and medium.

### BACKGROUND ART

A device that determines whether or not equipment is normal by diagnosing time series data of the equipment to be diagnosed using a learning model learned using time series data of normal equipment has been studied and developed. Herein, when learning the learning model, it is important to know in advance how much data should be used to perform learning. In order to perform abnormality detection and the like at an early stage, it is desired to perform learning as early as possible. On the other hand, if learning is performed in a state where data is not sufficiently collected, and it is found that the data is insufficient after learning, rework to perform learning again is necessary. Conversely, if a large amount of data is input and learned, learning itself takes time, and there is a possibility that over-learning occurs. Thus, it is necessary to discard unnecessary data in the collected data for learning.

Therefore, a technique of determining whether or not the amount of collected time-series data is sufficient for performing learning of a learning model has been studied. For example, Patent Literature 1 discloses a data processing device that calculates a feature amount for each region obtained by dividing data into sections, classifies the feature amount of each region into patterns, and ends learning when the number of patterns converges.

### CITATION LIST

### Patent Literatures

Patent Literature 1: JP 2009-135649 A

### SUMMARY OF INVENTION

### Technical Problem

However, the data processing device disclosed in Patent Literature 1 only determines the sufficiency of data on the basis of the number of patterns of the feature amount, and cannot flexibly cope with time series data having various characteristics, and has a problem that the accuracy of determining the sufficiency of the data amount is low depending on the characteristics of the time series data.

The present disclosure has been made to solve the above-described problems, and an object thereof is to obtain a data amount sufficiency determination device capable of determining the sufficiency of the data amount of learning data with higher accuracy.

### Solution to Problem

A data amount sufficiency determination device according to the present disclosure includes processing circuitry configured to: acquire time series data, divide the time series data into a plurality of pieces of substring data, generate a plurality of substring data sets that are sets of substring data, calculate a feature amount of the substring data, generate probability distribution of the feature amount for each of the substring data set, and determine whether or not the probability distribution has converged.

### Advantageous Effects of Invention

A data amount sufficiency determination device according to the present disclosure includes a feature amount calculation unit to calculate a feature amount of substring data, a probability distribution generation unit to generate probability distribution of the feature amount for each of substring data set, and a determination unit to determine whether or not the probability distribution has converged. Therefore, it is possible to determine the sufficiency of a data amount of learning data with higher accuracy not only based on the number of patterns of the feature amount but also based on the probability distribution of the feature amount.

### BRIEF DESCRIPTION OF DRAWINGS

FIG. 1 is a configuration diagram illustrating the configuration of a learning model generation system 1000 according to a first embodiment.

FIG. 2 is a hardware configuration diagram illustrating an example of the hardware configuration of a data amount sufficiency determination device 100 according to the first embodiment.

FIG. 3 is a flowchart illustrating the operation of the data amount sufficiency determination device 100 according to the first embodiment.

FIG. 4 is a conceptual diagram for explaining a specific example of processing in which a data division unit 20 according to the first embodiment divides time-series data.

FIG. 5 is a conceptual diagram for explaining a specific example of processing in which a data set generation unit 30 according to the first embodiment generates a substring data set.

FIG. 6 is a conceptual diagram for explaining a specific example of processing in which a probability distribution generation unit 50 according to the first embodiment generates a probability distribution.

FIG. 7 is a conceptual diagram for explaining a specific example of processing in which the probability distribution generation unit 50 according to the first embodiment calculates a statistic amount.

FIG. 8 is a configuration diagram illustrating the configuration of a learning model generation system 2000 according to a second embodiment.

FIG. 9 is a conceptual diagram for explaining a specific example of processing of a feature amount calculation unit 240 according to the second embodiment.

FIG. 10 is a conceptual diagram for explaining a specific example of processing of the data amount sufficiency determination device according to the first embodiment and the second embodiment.

FIG. 11 is a configuration diagram illustrating the configuration of a learning model generation system 3000 according to a third embodiment.

FIG. 12 is a conceptual diagram for explaining a specific example of processing of the data amount sufficiency determination device 300 according to the third embodiment.

FIG. 13 is a configuration diagram illustrating the configuration of a learning model generation system 4000 according to a fourth embodiment.

FIG. 14 is a conceptual diagram for explaining a specific example of processing of a data amount sufficiency determination device 400 according to the fourth embodiment.

FIG. 15 is a configuration diagram illustrating the configuration of a learning model generation system 5000 according to a fifth embodiment.

FIG. 16 is a configuration diagram illustrating the configuration of a learning model generation system 6000 according to a sixth embodiment.

FIG. 17 is a conceptual diagram for explaining a specific example of processing of a data amount sufficiency determination device 600 according to the sixth embodiment.

### DESCRIPTION OF EMBODIMENTS

### First Embodiment

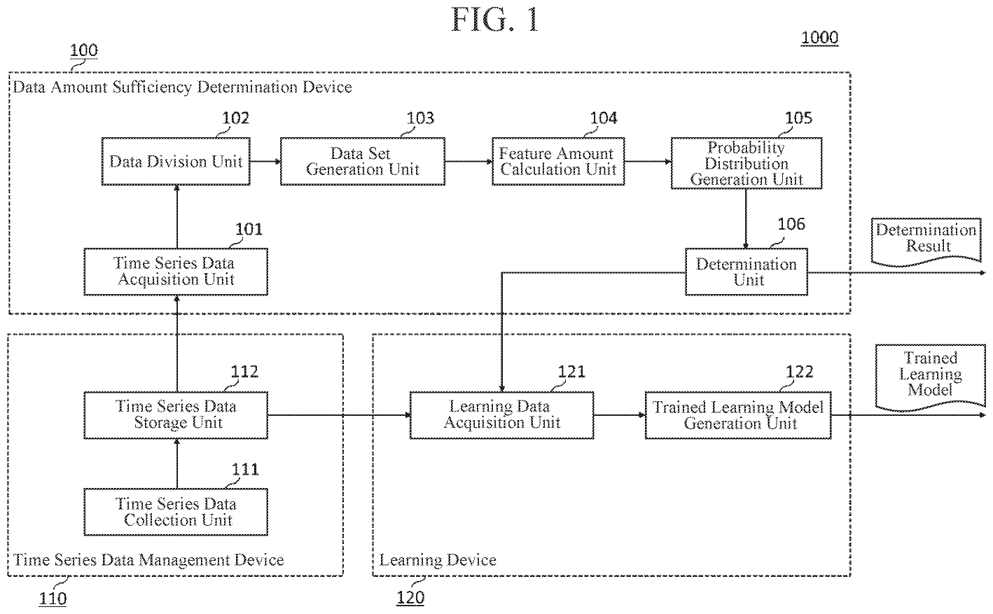

FIG. 1 is a configuration diagram illustrating the configuration of a learning model generation system 1000 according to a first embodiment.

The learning model generation system 1000 collects time series data and generates a learning model, and includes a data amount sufficiency determination device 100, a time series data management device 110, and a learning device 120.

The data amount sufficiency determination device 100 determines whether the data collected by the time series data management device 110 is collected in an amount sufficient for the learning device 120 to learn the learning model.

The time series data management device 110 manages time series data, and includes a time series data collection unit 111 that collects time series data and a time series data storage unit 112 that stores the collected time series data.

Herein, for example, a sensor or the like provided in a production facility is used as the time series data collection unit 111, and a storage device such as a hard disk is used as the time series data storage unit 112.

The learning device 120 learns the learning model by using the time series data received from the time series data management device 110 in a case where the data amount sufficiency determination device 100 determines that a sufficient data amount is collected, and includes a learning data acquisition unit 121 that acquires the time series data stored in the time series data management device 110 as learning data and a trained model generation unit 122 that learns the learning model by using the learning data acquired by the learning data acquisition unit 121 and generates a trained model.

Similar to the data amount sufficiency determination device 100 to be described later, each function of the learning device 120 is achieved by a processing device executing a program stored in the storage device.

Next, details of the data amount sufficiency determination device 100 will be described.

The data amount sufficiency determination device 100 includes a time series data acquisition unit 101, a data division unit 102, a data set generation unit 103, a feature amount calculation unit 104, a probability distribution generation unit 105, and a determination unit 106.

The time series data acquisition unit 101 acquires time series data. The time-series data is, for example, data indicating a current value or a voltage value acquired by a sensor attached to a manufacturing apparatus, vibration data indicating vibration of a device detected by a vibration sensor, sound data indicating an operation sound of a device detected by a sound sensor, or the like.

In the first embodiment, the time series data acquisition unit 101 acquires the time series data to be learned from the time series data storage unit 112. Herein, the time series data acquisition unit 101 acquires a large amount of time series data as a target for determining the sufficiency of the data amount. The acquired time series data is digital data in which time and data are associated, and continuous values are converted into discrete data at a specific sampling rate.

The data division unit 102 divides the time series data acquired by the time series data acquisition unit 101 into a plurality of pieces of substring data. That is, the data division unit 102 generates a plurality of pieces of substring data by dividing the time series data. More specifically, the data division unit 102 according to the first embodiment extracts W pieces of temporally continuous data from the acquired time series data. The extracted W pieces of data are referred to as substring data.

Herein, the data division unit 102 can generate the substring data so that the plurality of substring data includes data in a common time period. Therefore, a situation in which the characteristics of the waveform change can be grasped finely, and the determination accuracy is improved.

The data set generation unit 103 generates a plurality of substring data sets which are sets of the substring data generated by the data division unit 102. Moreover, the data set generation unit 103 generates a second substring data set by adding the substring data not included in a first substring data set to the first substring data set. That is, in the first embodiment, the data set generation unit 103 generates a plurality of substring data sets by gradually increasing the data amount. Moreover, in the first embodiment, the data set generation unit 103 generates a plurality of groups including a plurality of substring data sets. More specifically, the data set generation unit 103 generates a first group having a plurality of substring data sets and a second group having the same number of substring data sets as the first group and having at least one substring data set not included in the first group.

The feature amount calculation unit 104 calculates a feature amount of the substring data generated by the data division unit 102. Herein, the feature amount does not necessarily correspond to the substring data on a one-to-one basis. That is, the feature amount calculation unit 104 may calculate the feature amount for each substring data, or may calculate the feature amount from the relationship between the substring data, and the feature amount of the substring data includes both of them. Furthermore, the feature amount is not limited to one, and a plurality of feature amounts may be calculated. However, in the following, the feature amount calculation unit 104 calculates the feature amount for each substring data. Moreover, the feature amount herein is, for example, an average or a standard deviation of each substring data, an average, a standard deviation, or the like of absolute values of slopes of waveforms representing the individual substring data.

The probability distribution generation unit 105 generates probability distribution of a feature amount for each substring data set generated by the data set generation unit 103. Herein, the probability distribution of the feature amount is distribution of probabilities of values taken by each feature amount in the plurality of pieces of substring data. For example, the probability distribution of the feature amount is obtained by dividing a range of values of the feature amount into sections having a constant width, obtaining the number (frequency) of values included in each section, and normalizing the obtained number. Moreover, in the first embodiment, the probability distribution generation unit 105 compares the probability distributions each generated from different substring data sets, and calculates a statistic of the feature amount on the basis of the probability distribution.

In the first embodiment, the probability distribution generation unit 105 calculates, as the statistic, the similarity between the probability distribution of the substring data set included in the first group and the probability distribution of the substring data set included in the second group. As the similarity, for example, a Euclidean distance or a cosine similarity is used.

The determination unit 106 determines whether or not the probability distribution generated by the probability distribution generation unit 105 has converged. The determination unit 106 determines whether or not the data amount is sufficient by determining whether or not the probability distribution has converged. That is, the determination unit 106 determines that the data amount is sufficient based on the convergence of the probability distribution. In the first embodiment, the determination unit 106 determines that the probability distribution has converged in a case where the similarity between the probability distributions calculated by the probability distribution generation unit 105 converges, that is, in a case where the change in the feature amount obtained from the probability distribution decreases or disappears. The determination unit 106 outputs the determination result to the learning data acquisition unit 121.

Moreover, the determination unit 106 outputs the determination result to a display device (not illustrated) such as a display, and causes the display device to display the determination result.

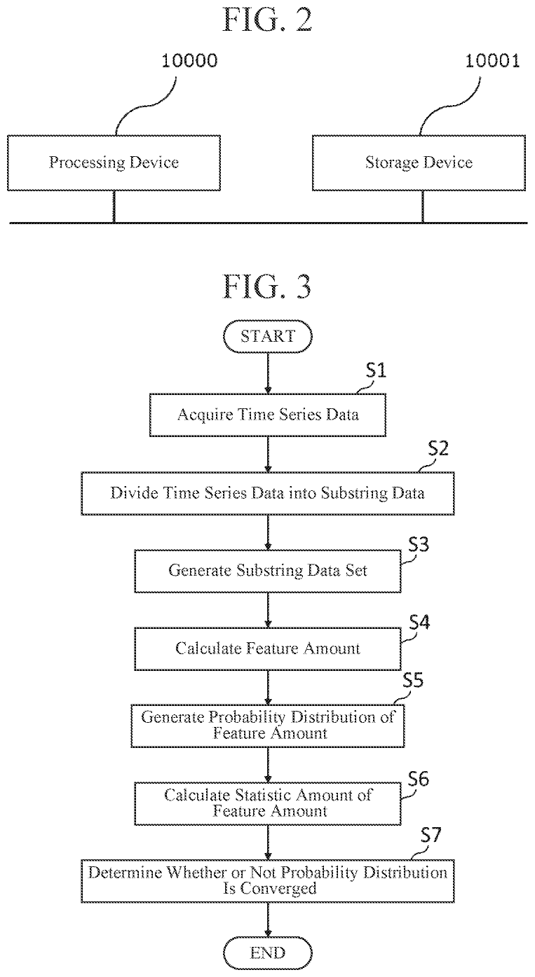

Next, the hardware configuration of the data amount sufficiency determination device 100 according to the first embodiment will be described. Each function of the data amount sufficiency determination device 100 is achieved by a computer. FIG. 2 is a hardware configuration diagram illustrating an example of the hardware configuration of a computer that implements the data amount sufficiency determination device 100 according to the first embodiment.

The hardware illustrated in FIG. 2 includes a processing device 10000 such as a central processing unit (CPU), and a storage device 10001 such as a read only memory (ROM), a random access memory (RAM), and a hard disk.

The time series data acquisition unit 101, the data division unit 102, the data set generation unit 103, the feature amount calculation unit 104, the probability distribution generation unit 105, and the determination unit 106 illustrated in FIG. 1 are implemented by the processing device 10000 executing a program stored in the storage device 10001. Herein, the above configuration is not limited to the configuration implemented by a single processing device 10000 and a single storage device 10001, and may be the configuration implemented by a plurality of processing devices 10000 and a plurality of storage devices 10001.

Moreover, a method of implementing each function of the data amount sufficiency determination device 100 is not limited to the above-described combination of hardware and a program, and may be achieved by a single piece of hardware such as a large scale integrated circuit (LSI) in which a program is implemented in a processing device, or some functions may be achieved by dedicated hardware, and some may be achieved by a combination of a processing device and a program.

The data amount sufficiency determination device 100 according to the first embodiment is configured as described above.

Next, the operation of the data amount sufficiency determination device 100 according to the first embodiment will be described.

FIG. 3 is a flowchart illustrating the operation of the data amount sufficiency determination device 100 according to the first embodiment.

Moreover, in the following description, the operation of the data amount sufficiency determination device 100 corresponds to a data amount sufficiency determination method, and a program for causing a computer to execute the operation of the data amount sufficiency determination device 100 corresponds to a non-transitory computer readable medium with a data amount sufficiency determination program stored thereon. Furthermore, the operation of the learning model generation system 1000 corresponds to a trained model generation method, and a program for causing a computer to execute the operation of the learning model generation system 1000 corresponds to a non-transitory computer readable medium with a trained model generation program stored thereon. In addition, the operation of the time series data acquisition unit 101 corresponds to a time series data acquisition step, the operation of the data division unit 102 corresponds to a data division step, the operation of the data set generation unit 103 corresponds to a data set generation step, the operation of the feature amount calculation unit 104 corresponds to a feature amount calculation step, the operation of the probability distribution generation unit 105 corresponds to a probability distribution generation step, the operation of the determination unit 106 corresponds to a determination step, the operation of the learning data acquisition unit 121 corresponds to a learning data acquisition step, and the operation of the trained model generation unit 122 corresponds to a trained generation step.

First, in Step S1, when a user of the data amount sufficiency determination device 100 manipulates an input interface (not illustrated) to input a request to start the data amount sufficiency determination processing, the time series data acquisition unit 101 acquires the time series data to be determined from the time series data storage unit 112.

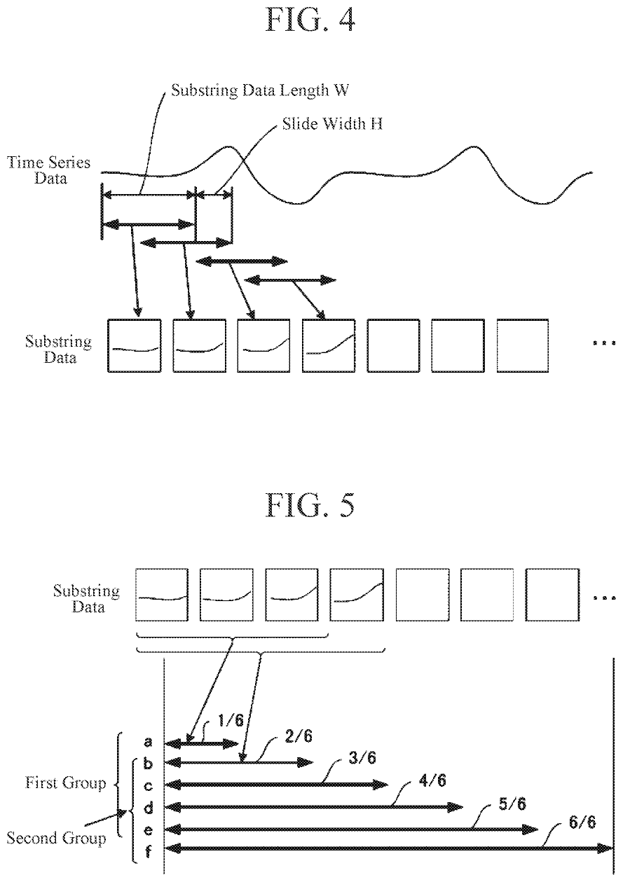

Next, in Step S2, the data division unit 102 divides the time series data acquired by the time series data acquisition unit 101 in step S1 into substring data. A specific example of processing in which the data division unit 102 divides the time series data will be described with reference to FIG. 4. FIG. 4 is a conceptual diagram for explaining a specific example of processing in which the data division unit 102 according to the first embodiment divides time series data.

As illustrated in FIG. 4, the data division unit 102 extracts W pieces of temporally continuous data from the acquired time series data as substring data. Herein, W is referred to as a substring data length. Then, the data division unit 102 sequentially generates the plurality of pieces of substring data while gradually shifting the time of the target at which the substring data is extracted. The length, by which the substring data is shifted, is referred to as a slide width H. The slide width H is decided by a trade-off between the accuracy of the data amount sufficiency determination and the calculation amount. Herein, as an example, H=W/2.

Returning to FIG. 3, the subsequent operation will be described.

Next, in Step S3, the data set generation unit 103 collects the substring data extracted in Step S2 and generates a plurality of substring data sets. A specific example of processing in which the data set generation unit 103 generates a substring data set will be described with reference to FIG. 5. FIG. 5 is a conceptual diagram for explaining a specific example of processing in which the data set generation unit 103 according to the first embodiment generates a substring data set.

As illustrated in FIG. 5, the data set generation unit 103 generates substring data sets of a, b, c, and so on from the plurality of pieces of substring data. Moreover, the data set generation unit 103 generates a first group and a second group including a plurality of substring data sets in which the data amount of the substring data set is increased stepwise. Specifically, as illustrated in FIG. 5, the group generation unit 13 sets, as a first group, substring data sets a, b, c, d, and e whose proportions with respect to the entire substring data are 1/6, 2/6, 3/6, 4/6, and 5/6, and sets, as a second group, substring data sets b, c, d, e, and f whose proportions with respect to the entire time series data are 2/6, 3/6, 4/6, 5/6, and 6/6.

Returning to FIG. 3, the subsequent operation will be described.

Next, in Step S4, the feature amount calculation unit 104 calculates a plurality of feature amounts for each substring data set. For example, assuming that the substring data set a includes 10 pieces of substring data, 10 pieces of feature amount with respect to a are obtained by calculating the feature amount for each substring data.

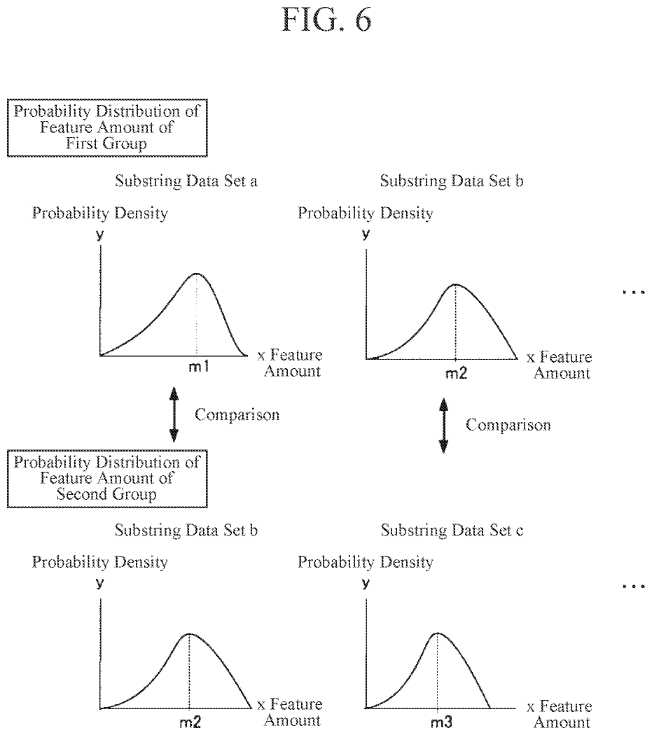

Next, in Step S5, the probability distribution generation unit 105 generates probability distribution of the feature amount for each substring data set. A specific example of the probability distribution generated by the probability distribution generation unit 105 will be described with reference to FIG. 6. FIG. 6 is a conceptual diagram for explaining a specific example of processing in which the probability distribution generation unit 105 according to the first embodiment generates probability distribution.

As illustrated in FIG. 6, the probability distribution generation unit 105 generates probability distribution representing the relationship between probability density y and a feature amount x for each of the substring data sets a, b, c, d, e and f.

Returning to FIG. 3, the subsequent operation will be described.

In Step S6, the probability distribution generation unit 105 calculates a statistic of the feature amount from the probability distribution of the individual substring data set.

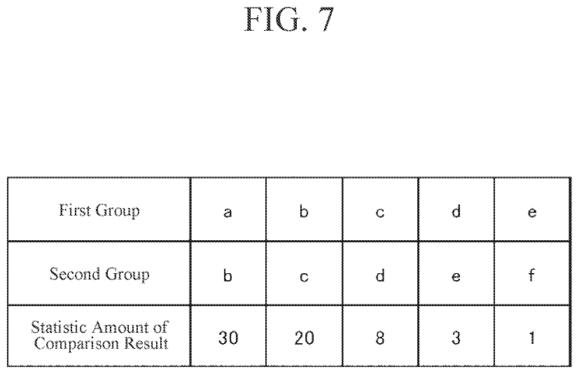

A specific example of processing in which the probability distribution generation unit 105 calculates the statistic will be described with reference to FIG. 7. FIG. 7 is a conceptual diagram for explaining a specific example of processing in which the probability distribution generation unit 105 according to the first embodiment calculates a statistic.

First, as illustrated in FIG. 7, the probability distribution generation unit 105 calculates a statistic by comparing the probability distributions of a in the first group and b in the second group, and then calculates a statistic by comparing the probability distributions of b in the first group and c in the second group. In this way, the probability distribution generation unit 105 compares a, b, c, d, and e of the first group with b, c, d, e, and f of the second group, and obtains five statistics.

The probability distribution generation unit 105 calculates, for example, an absolute value of a difference between a mode m1 of the feature amount of the first group and a mode m2 of the feature amount of the second group as a statistic of the comparison result of the probability distribution. Alternatively, assuming that the probability density of the first group is y1 (x), the probability density of the second group is y2 (x), the minimum value of x is min, and the maximum value of x is max, the statistic may be calculated by the following equation.

Σₓ₌ₘᵢₙ^{max}(y1(x)−y2(x)² [Mathematical Formula 1]

Returning to FIG. 3, the subsequent operation will be described.

In Step S7, the determination unit 106 determines whether the probability distribution generated in Step S5 has converged. Herein, in the first embodiment, the determination unit 106 determines whether the probability distribution has converged by determining whether the statistic calculated in Step S6 has converged.

More specifically, the determination unit 106 compares the statistic of the comparison result of the substring data set having a small data amount, for example, a and b with the statistic of the comparison result of the substring data set having a large data amount, for example, e and f, and determines whether or not a predetermined reference condition or a dynamically decided reference condition is met, such as that the statistic of the substring data set having a large data amount is closer to 0, the difference in the statistic gradually decreases, and the statistic is smaller than the expected value based on the data amount of the substring data set. Then, in a case where the reference condition is met, the determination unit 106 determines that the amount of time series data is sufficient.

Herein, as the expected value based on the data amount of the substring data set, for example, there may be a method in which the number of substring data set included in the smaller substring data set of the comparison is set to n, a value when n is 1 is set to A, A/n and the like. This is because, suppose that the influence and the data amount have a linear relationship, if the data amount becomes n times, the influence when the same amount of data is additionally given is considered to be 1/n. The expected value is not limited to A/n, and may be A/(n), A/(n\hat{ }2), or the like.

Although the data amount sufficiency determination device 100 ends the operation as described above, the determination unit 106 may transmit the determination result to the display device to display the determination result or transmit the determination result to the learning device 120 to learn the learning model.

More specifically, in a case where the determination unit 106 determines that the probability distribution has converged, that is, in a case where the data amount is determined to be sufficient, the learning data acquisition unit 121 acquires the time series data from the time series data storage unit 112 as the learning data. Herein, the learning data acquired by the learning data acquisition unit 121 is the same as the data acquired by the time series data acquisition unit 101 used by the determination unit 106 to make determination. In addition, in a case where it is determined that the data amount is not sufficient, data excluded in advance may be added, or data may be additionally acquired.

Then, the trained model generation unit 122 performs learning of the learning model using the learning data acquired by the learning data acquisition unit 121 and generates a trained model.

With the above operation, the data amount sufficiency determination device 100 according to the first embodiment can determine the sufficiency of the learning data with higher accuracy not only based on merely the number of patterns of the feature amount but also based on the probability distribution of the feature amount.

Moreover, since the learning model generation system 1000 according to the first embodiment performs learning of the learning model in a case where the data amount sufficiency determination device 100 determines that the data amount is sufficient, it is possible to reduce the possibility of generating a trained model in which the data amount is insufficient and appropriate inference cannot be performed or the necessity of relearning.

Moreover, the data amount sufficiency determination device 100 according to the first embodiment generates the second substring data set by adding the substring data not included in the first substring data set to the first substring data set. That is, the data amount sufficiency determination device 100 generates a certain substring data set and compares the probability distributions of the feature amounts of the respective substring data sets to determine the sufficiency of the data amount. In short, in the first embodiment, the section to be subjected to the generation of the probability distribution is widened as compared with the third embodiment and the fourth embodiment to be described later, which is a simple method. Therefore, there is an effect that determination can be made with a small calculation amount.

Furthermore, the data amount sufficiency determination device 100 according to the first embodiment generates a first group including a plurality of substring data sets and a second group including the same number of substring data sets as the first group and including at least one substring data set not included in the first group, a statistic calculator calculates a similarity between the probability distribution of the substring data set included in the first group and the probability distribution of the substring data set included in the second group, and the determination unit determines that the probability distribution converges when the similarity converges, so that an effect that the order relationship is easy to understand, the visibility is good, and the determination of the sufficiency of the data amount is easy to understand is obtained.

In addition, although the description has been made using the group, the similar processing may be performed without explicitly forming the group. That is, the comparison between the probability density of the feature amount of the substring data set a and that of b, and the comparison between that of b and that of c may be repeated.

Moreover, since the data amount sufficiency determination device 100 according to the first embodiment calculates the feature amount for each substring data, it is possible to perform determination on the basis of the feature when attention is paid to each substring data itself instead of the relationship between the substring data as compared with the second embodiment to be described later. Thus, it is possible to achieve an effect that determination can be performed with high accuracy when the feature appears well in each substring data.

### Second Embodiment

Next, a learning model generation system 2000 according to a second embodiment will be described.

In the first embodiment, the feature amount calculation unit 104 included in the data amount sufficiency determination device 100 calculates the feature amount of each substring data. In the present embodiment, an example will be described in which the feature amount calculation unit 204 calculates a feature amount from a comparison pair of substring data, that is, calculates a feature amount obtained by comparing each piece of substring data with other substring data. Hereinafter, differences from the first embodiment will be mainly described.

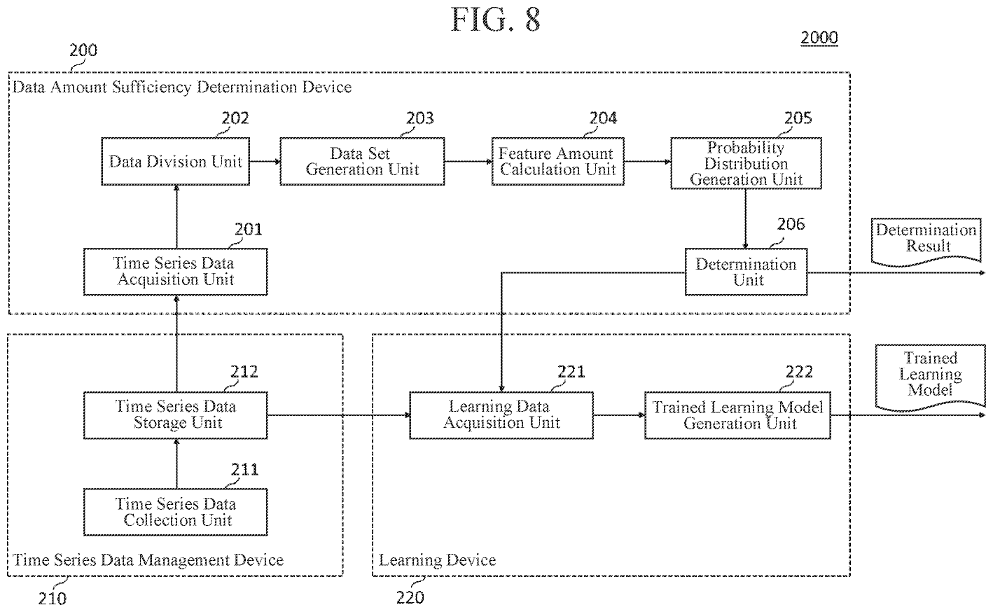

FIG. 8 is a configuration diagram illustrating the configuration of a learning model generation system 2000 according to the second embodiment. The learning model generation system 2000 includes a data amount sufficiency determination device 200, a time series data management device 210, and a learning device 220.

Similar to the first embodiment, the time series data management device 210 includes a time series data collection unit 211 and a time series data storage unit 212. Moreover, similar to the first embodiment, the learning device 220 also includes a learning data acquisition unit 221 and a trained model generation unit 222.

The data amount sufficiency determination device 200 includes a time series data acquisition unit 201, a data division unit 202, a data set generation unit 203, a feature amount calculation unit 204, a probability distribution generation unit 205, and a determination unit 206.

In the second embodiment, the feature amount calculation unit 204 selects two pieces of substring data included in each substring data set as a comparison pair, and calculates the feature amount of the selected comparison pair. That is, the feature amount calculation unit 240 calculates a comparison value between the first substring data and the second substring data as a feature amount. Specifically, the feature amount of the comparison pair corresponds to a feature amount indicating a degree of difference between substrings such as a Euclidean distance in a case where the substring is regarded as a point in the space and an angle in a case where the substring is regarded as a vector.

In the second embodiment, the feature amount calculation unit 204 repeats the selection of the comparison pair and the calculation of the feature amount to calculate the feature amounts of the plurality of comparison pairs.

In the second embodiment, the probability distribution generation unit 205 generates the probability distribution of the feature amount of each of the substring data sets of each group on the basis of the feature amounts of the plurality of comparison pairs calculated by the feature amount calculation unit 204.

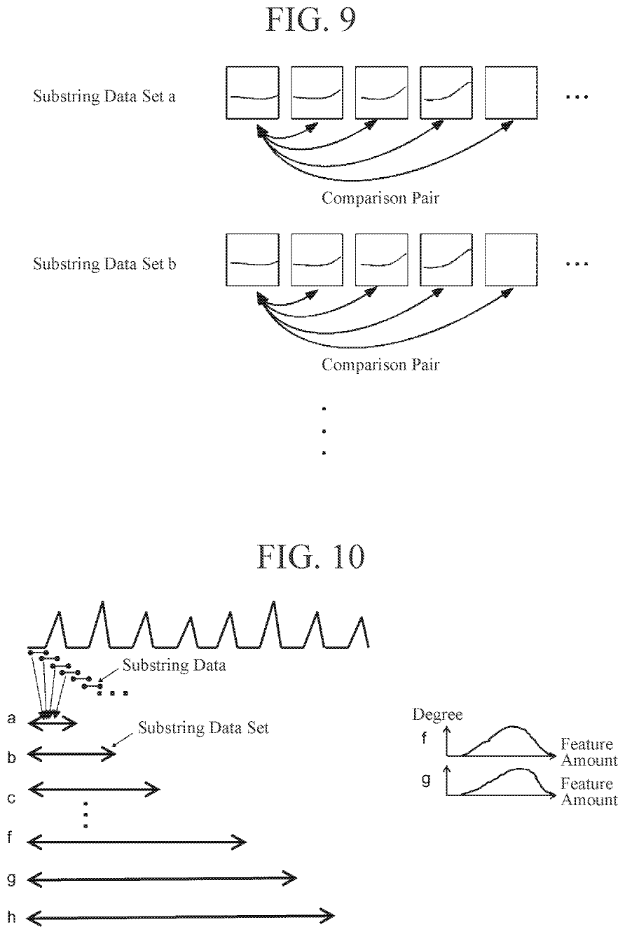

A specific example of processing of the feature amount calculation unit 204 will be described with reference to FIG. 9.

FIG. 9 is a conceptual diagram for explaining a specific example of processing of the feature amount calculation unit 240 according to the second embodiment.

As illustrated in FIG. 9, the feature amount calculation unit 240 selects the head substring data and the second substring data of the individual substring data set of each group as a comparison pair and calculates the feature amount. Next, the feature amount calculation unit 240 selects the head substring data and the third substring data as a comparison pair and calculates the feature amount. This is repeated to calculate the feature amounts of the extracted comparison pairs.

Note that, in a case where the nearest distance calculated by the nearest neighbor search is set as the feature amount, the feature amount calculation unit 240 performs the nearest neighbor search by excluding the same data portion in the individual substring data set. Furthermore, the feature amount calculation unit 14 may use a k-neighbor distance calculated by k-neighbor search as the feature amount.

Other components and operations are the same as those in the first embodiment, and thus description thereof is omitted.

The data amount sufficiency determination device 200 according to the second embodiment calculates a comparison value between the first substring data and the second substring data as a feature amount. That is, the data amount sufficiency determination device 200 determines the sufficiency of the data amount on the basis of the feature amount obtained by comparing the substring data. This enables determination flexibly corresponding to time series data having various characteristics.

### Third Embodiment

Next, a data amount sufficiency determination device 300 according to a third embodiment will be described.

In the first embodiment and the second embodiment, as illustrated in FIG. 10, it is assumed that a substring data set gradually increases and includes a previous substring data set, but in the third embodiment, an example in which a substring data set is generated by a different method will be described. Hereinafter, differences from the first embodiment and second embodiment will be mainly described.

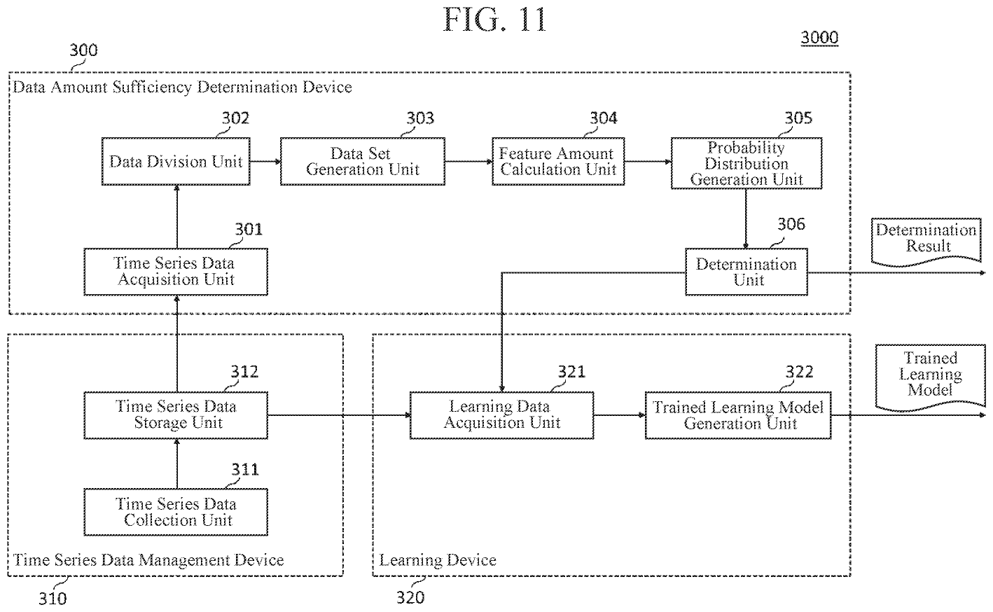

FIG. 11 is a configuration diagram illustrating the configuration of a learning model generation system 3000 according to the third embodiment. The learning model generation system 3000 includes a data amount sufficiency determination device 300, a time series data management device 310, and a learning device 320.

Similar to the other embodiments, the time series data management device 310 includes a time series data collection unit 311 and a time series data storage unit 312. Moreover, similar to other embodiments, the learning device 320 also includes a learning data acquisition unit 321 and a trained model generation unit 322.

The data amount sufficiency determination device 300 includes a time series data acquisition unit 301, a data division unit 302, a data set generation unit 303, a feature amount calculation unit 304, a probability distribution generation unit 305, and a determination unit 306.

In the third embodiment, the data set generation unit 303 generates a first substring data set and a second substring data set not including substring data common to the first substring data set. Furthermore, the data set generation unit 303 generates a third substring data set obtained by combining the first substring data set and at least one substring data included in the second substring data set. That is, in the third embodiment, the data set generation unit 303 repeats creation of the substring data set so as to divide the plurality of substring data into two substring data sets while increasing the number of substring data.

Moreover, in the third embodiment, the probability distribution generation unit 305 calculates an average value of the feature amounts on the basis of the probability distribution, and the determination unit 306 determines that the probability distribution has converged in a case where the average value falls within a predetermined range. Herein, the amount used by the probability distribution generation unit 305 and the determination unit 306 may be not an average value, and may be, for example, a median value, an average value obtained by excluding outliers, or the like.

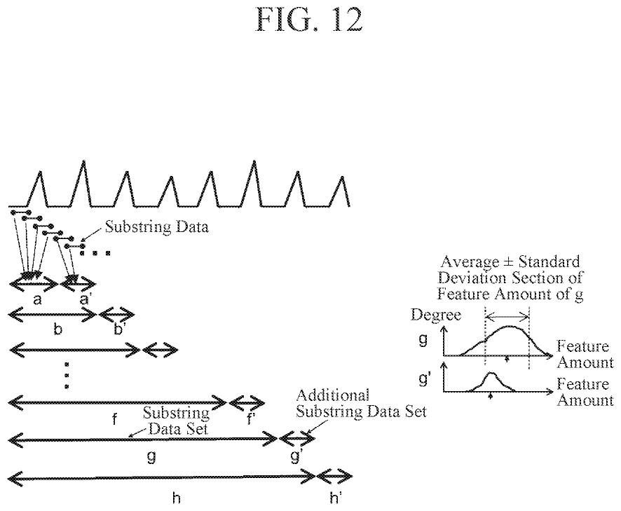

A specific example of processing of the data amount sufficiency determination device 300 according to the third embodiment will be described with reference to FIG. 12.

FIG. 12 is a conceptual diagram for explaining a specific example of processing of the data amount sufficiency determination device 300 according to the third embodiment.

As illustrated in FIG. 12, the data set generation unit 303 generates a combination of a certain substring data set and a substring data set that does not overlap with the certain substring data set. The latter is referred to as an additional substring data set.

In addition, as illustrated in FIG. 12, the probability distribution generation unit 305 generates the probability distribution of the feature amount for each of the substring data set and the additional substring data set. Then, the determination unit 306 compares the probability distribution of the substring data set with the probability distribution of the additional substring data set. For example, first, a and a′ in the drawing are compared, and then b and b′ are compared. Then, if the distribution of the feature amount of the additional substring data set falls within the range of the distribution of the feature amount of the corresponding substring data set, it is judged that the data amount is sufficient. More specifically, there is a method of judging that it is sufficient if the average of the feature amounts of the additional substring data set g′ is included in the average±standard deviation section of the feature amounts of the substring data set g. The judgment may be made using a maximum value, a minimum value, a quartile point, or the like in addition to the average of the distribution of the feature amounts.

Note that, in FIG. 12, the substring data set obtained by combining a and a′ is the next substring data set b, but it is not limited thereto. a and a′ may correspond to the whole b and a part of b′, or a and a′ may correspond to a part of b.

The data amount sufficiency determination device 300 according to the third embodiment generates a first substring data set and a second substring data set not including substring data common to the first substring data set, and further generates a third substring data set obtained by combining the first substring data set and at least one substring data included in the second substring data set. That is, by repeating the operation of comparing the probability distributions of a certain substring data set (first substring data set) and an additional substring data set (second substring data set), and then comparing the probability distributions of a substring data set (third substring data set) obtained by combining the substring data set and the additional substring data set with the probability distribution of a new additional substring data set (fourth substring data set), the sufficiency of the data amount is determined.

As described above, by not including the common substring data in the substring data set to be compared, the characteristics of the time series data can be grasped in more detail, and effect can be exerted where the sufficiency of the data amount is more accurately determined. In addition, as compared with the first and second embodiments, the distribution in the substring data set in a narrower period is referred to, the characteristics of the time series data can be grasped in more detail, and the sufficiency of the data amount can be determined more accurately.

In addition, in combination with the second embodiment, the feature amount calculation unit 240 may calculate the feature amount from the comparison pair of the substring data.

### Fourth Embodiment

Next, a data amount sufficiency determination device 400 according to a fourth embodiment will be described.

An embodiment in which a substring data set is generated by a method different from the data amount sufficiency determination devices according to the first to third embodiments will be described.

Hereinafter, differences from the other embodiments will be mainly described.

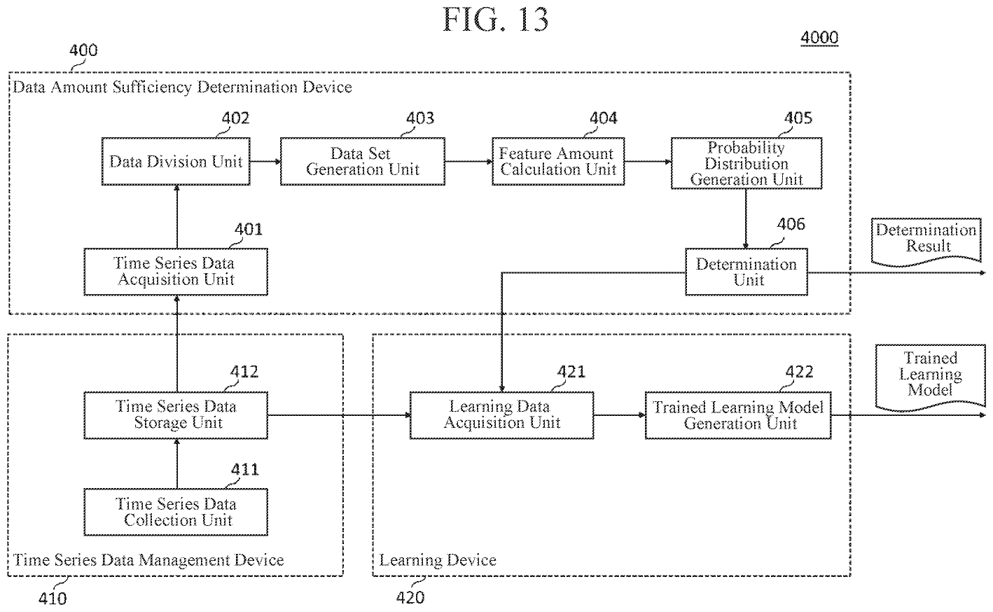

FIG. 13 is a configuration diagram illustrating the configuration of a learning model generation system 4000 according to the fourth embodiment. The learning model generation system 4000 includes a data amount sufficiency determination device 400, a time series data management device 410, and a learning device 420.

Similar to the other embodiments, the time series data management device 410 includes a time series data collection unit 411 and a time series data storage unit 412. Moreover, similar to other embodiments, the learning device 420 also includes a learning data acquisition unit 421 and a trained model generation unit 422.

The data amount sufficiency determination device 400 includes a time series data acquisition unit 401, a data division unit 402, a data set generation unit 403, a feature amount calculation unit 404, a probability distribution generation unit 405, and a determination unit 406.

In the fourth embodiment, the data set generation unit 403 generates a first substring data set and a second substring data set not including substring data common to the first substring data set. Moreover, the data set generation unit 403 generates a third substring data set not including substring data common to the first substring data set and the second substring data set.

In this manner, the data set generation unit 403 repeatedly generates a substring data set that does not include substring data common to other substring data sets.

Moreover, in the fourth embodiment, the probability distribution generation unit 405 calculates an average value of the feature amounts on the basis of the probability distribution, and the determination unit 406 determines that the probability distribution has converged in a case where the average value falls within a predetermined range. Similar to the third embodiment, the amount used by the probability distribution generation unit 405 and the determination unit 406 may be not an average value, and may be, for example, a median value, an average value obtained by excluding outliers, or the like.

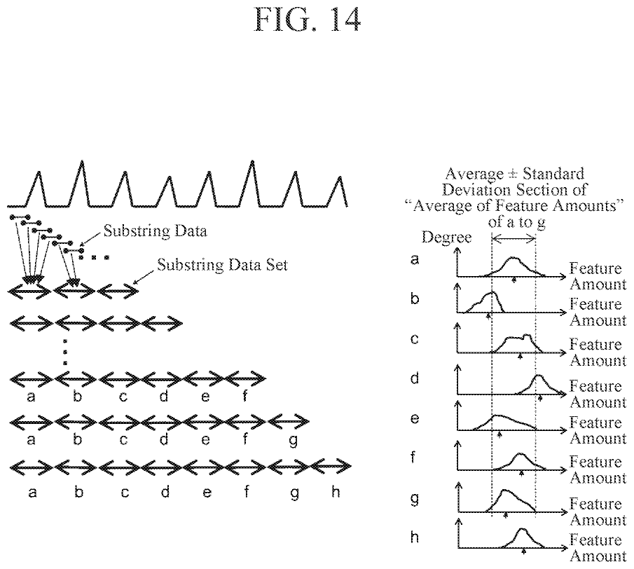

A specific example of processing of the data amount sufficiency determination device 400 according to the fourth embodiment will be described with reference to FIG. 14.

FIG. 14 is a conceptual diagram for explaining a specific example of processing of the data amount sufficiency determination device 400 according to the fourth embodiment.

As illustrated in FIG. 14, the data set generation unit 403 generates a plurality of substring data sets not including common substring data. Then, the determination unit 406 compares the probability distributions of the feature amounts of the plurality of substring data sets with that of one or more substring data sets. For example, a, b, c, d, e, and f are compared with g, and then a, b, c, d, e, f, and g are compared with h. For example, if the probability distribution of the feature amount of a new substring data set falls within the variation in the distribution of the feature amount of the substring data set so far, it is judged that the data is sufficient. Specifically, it is judged that it is sufficient if the average of the feature amounts of h falls within the N times section of the average±standard deviation of the “average of the feature amounts” of a to g. The judgment may be made using a maximum value, a minimum value, a quartile point, or the like in addition to the average of the distribution of the feature amounts.

The data amount sufficiency determination device 400 according to the fourth embodiment generates a first substring data set and a second substring data set not including substring data common to the first substring data set, and further generates a third substring data set not including substring data common to the first substring data set and the second substring data set. That is, the data amount sufficiency determination device 400 determines the sufficiency of the data amount by repeatedly generating a substring data set not including the common substring data and comparing the probability distributions of the feature amounts of the respective substring data sets.

As described above, by not including the common substring data in the substring data set to be compared, the characteristics of the time series data can be grasped in more detail, and effect can be exerted where the sufficiency of the data amount is more accurately determined. In addition, as compared with the data amount sufficiency determination device according to the third embodiment, since the data amount is further divided into substring data sets in a narrow period and the respective distributions are referred to, the characteristics can be grasped in more detail, and more accurate determination can be performed.

In addition, in combination with the second embodiment, the feature amount calculation unit 240 may calculate the feature amount from the comparison pair of the substring data.

### Fifth Embodiment

Next, a data amount sufficiency determination device 500 according to a fifth embodiment will be described.

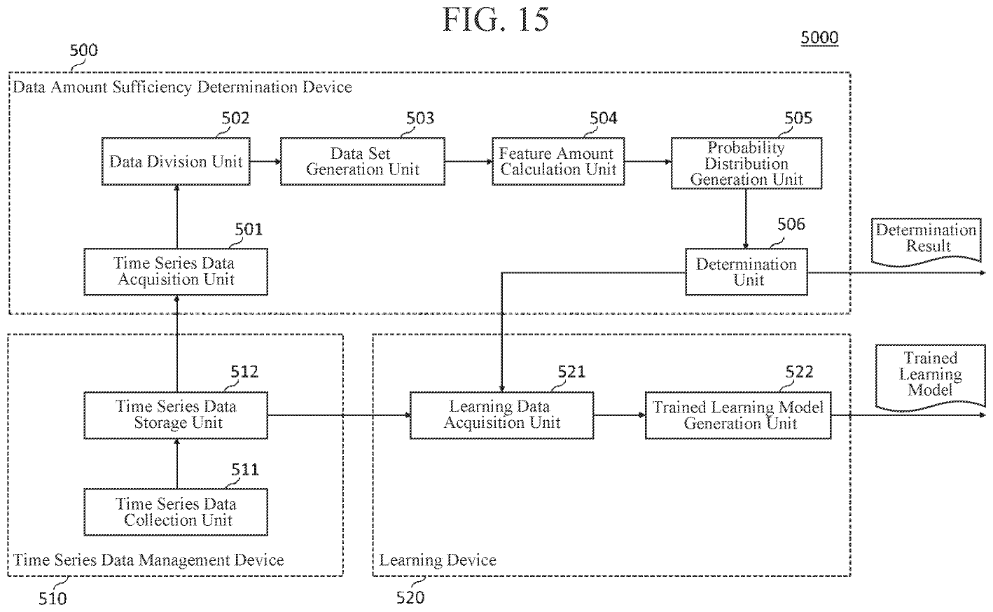

FIG. 15 is a configuration diagram illustrating the configuration of a learning model generation system 5000 according to the fifth embodiment. The learning model generation system 5000 includes a data amount sufficiency determination device 500, a time series data management device 510, and a learning device 520.

Similar to other embodiments, the time series data management device 510 includes a time series data collection unit 511 and a time series data storage unit 512. Moreover, similar to other embodiments, the learning device 520 also includes a learning data acquisition unit 521 and a trained model generation unit 522.

The data amount sufficiency determination device 500 includes a time series data acquisition unit 501, a data division unit 502, a data set generation unit 503, a feature amount calculation unit 504, a probability distribution generation unit 505, and a determination unit 506.

Although the mode of determining whether or not the data is sufficient on the basis of one comparison result has been described so far, the determination unit 506 according to the fifth embodiment determines that the data is sufficient by combining a plurality of comparison results. For example, it may be determined as sufficient when the comparison results meet the reference condition M times in a row, or it may be determined as sufficient when the comparison results meet the reference condition P times or more in the last M times.

Since the data amount sufficiency determination device 500 according to the fifth embodiment makes the determination on the basis of the comparison results of a plurality of times instead of one time, the possibility of erroneous determination is reduced, and the determination accuracy is improved.

The fifth embodiment may be combined with the first to fourth embodiments as appropriate.

### Sixth Embodiment

Next, a sixth embodiment will be described.

In the first to fifth embodiments, one starting point is used when the substring data and the substring data set are acquired, but in the sixth embodiment, the substring data and the substring data set are generated on the basis of a plurality of starting points. Hereinafter, differences from the first to fifth embodiments will be mainly described.

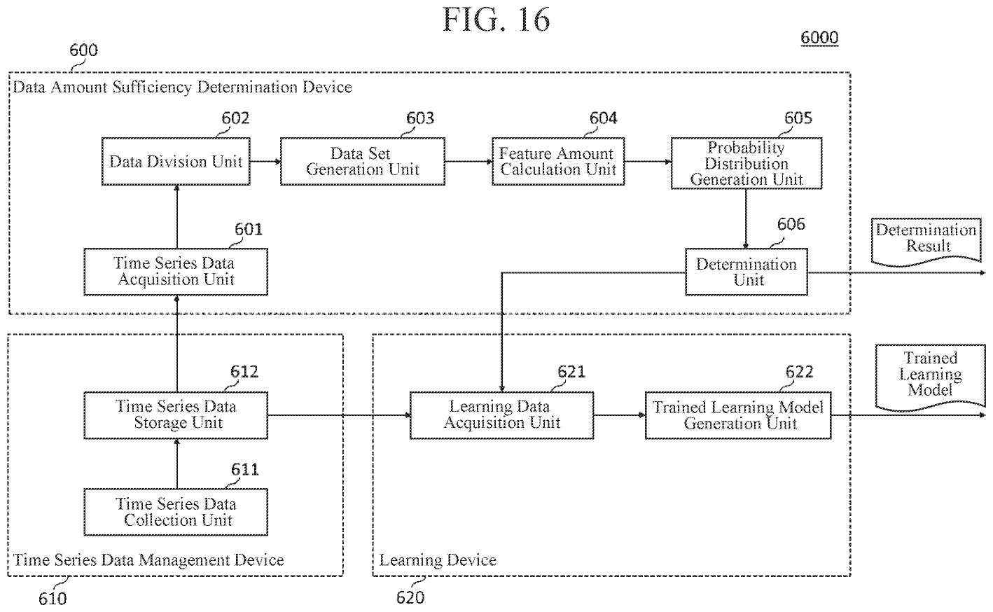

FIG. 16 is a configuration diagram illustrating the configuration of a learning model generation system 6000 according to the sixth embodiment. The learning model generation system 6000 includes a data amount sufficiency determination device 600, a time series data management device 610, and a learning device 620.

Similar to other embodiments, the time series data management device 610 includes a time series data collection unit 611 and a time series data storage unit 612. Moreover, similar to other embodiments, the learning device 620 also includes a learning data acquisition unit 621 and a trained model generation unit 622.

The data amount sufficiency determination device 600 includes a time series data acquisition unit 601, a data division unit 602, a data set generation unit 603, a feature amount calculation unit 604, a probability distribution generation unit 605, and a determination unit 606.

In the sixth embodiment, the data set generation unit 603 generates a first set having a plurality of substring data sets from time series data included from a first time to a second time, and generates a second set having a plurality of substring data sets from time series data included from a third time to a fourth time. Herein, the set is an amount that has a plurality of substring data sets and is a unit for the determination unit 606 to determine whether the reference condition is met. The first set is a collection of substring data sets on the basis of a first starting point, and the second set is a collection of substring data sets on the basis of a second starting point. Herein, the first time is a first starting point, and the third time is a second starting point. Moreover, the position of the second time, that is, the end point of the first set, and the position of the third time, that is, the end point of the second set are arbitrary, and regarding the order relationship between the second time (first end point) and the third time (second starting point), either may precede, but a situation will be considered in which the third time (second starting point) is a time later than the first time (first starting point).

Then, when both the first set and the second set meet the reference condition, the determination unit 606 determines that the amount of time series data is sufficient. Herein, the data set generation unit 603 may further generate the third set and subsequent sets, and the determination unit 606 may determine that the amount of time series data is sufficient in a case where the reference condition is met in all of the first set to the third set.

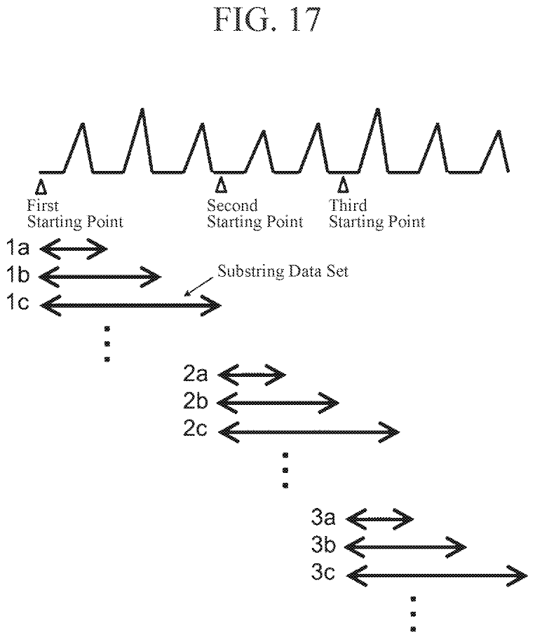

A specific example of processing of the data amount sufficiency determination device 600 according to the sixth embodiment will be described with reference to FIG. 17.

FIG. 17 is a conceptual diagram for explaining a specific example of processing of the data amount sufficiency determination device 600 according to the sixth embodiment.

As illustrated in FIG. 17, the data set generation unit 603 generates a substring data set on the basis of the first starting point as 1a, 1b, 1c and so forth, and a substring data set on the basis of the second starting point as 2a, 2b, 2c and so forth. Then, the determination unit 606 determines whether the data is sufficient by determining whether the probability distribution has converged for each starting point, and determines whether the data is sufficient as a final determination result by combining the determination results. The positions of the starting points may be determined at regular intervals or may be determined randomly.

The target data does not need to be a periodic waveform, but a waveform in which a specific pattern repeatedly appears and any of the assumed waveforms appears at any timing is assumed. In the case of the normal waveform, there is no mixture of unassumed waveforms, and in the case of mixture, it is an abnormal waveform. On the basis of such an assumption, it is expected that a sufficient amount of data from the starting point at the position of each start point is approximately the same amount of data. Therefore, this method can be used.

In the data amount sufficiency determination device 600 according to the sixth embodiment, the data set generation unit 603 generates a first set having a plurality of substring data sets from time series data included from a first time to a second time, and generates a second set having a plurality of substring data sets from time series data included from a third time to a fourth time, and the determination unit 606 determines that the amount of time series data is sufficient in a case where a predetermined condition is met in both the first set and the second set. That is, since the data amount sufficiency determination device 600 makes the determination on the basis of not one but a plurality of starting points, effects are exerted in which the possibility of erroneous determination is reduced, and the determination accuracy is improved.

Moreover, the sixth embodiment may be combined with the first to fifth embodiments as appropriate.

Hereinafter, a modification example of the data amount sufficiency determination device according to the present disclosure will be described.

The method of generating the substring data set described in the above embodiments is merely an example, and other generation methods may be used as long as the object and function of the invention are met. For example, although the example in which the data amount of the substring data set is increased at regular intervals has been described, the interval may be gradually increased (e.g., exponentially increased) or the interval may be gradually decreased (e.g., logarithmically increased). In the case of the first embodiment, since the additional amount of data is relatively reduced with respect to the data amount so far, it is conceivable that the difference in the comparison result of the distribution of the feature amount becomes small or the error in the comparison result of the distribution of the feature amount becomes large with respect to the expected value. Therefore, in order to prevent them, it is effective to gradually increase the interval. In addition, assuming that the data amount approaches a sufficient amount as the data increases, there is a possibility that it can be determined that the data amount is sufficient with higher accuracy by gradually and finely checking the data amount. In such a case, it is effective to gradually reduce the interval.

Furthermore, the data set generation unit may generate the substring data of the first group and the substring data of the second group with the same data amount.

Moreover, the probability distribution comparison method described in the above-described embodiment is merely an example, and other comparison methods may be used as long as the object and function of the invention are met. For example, the probability distribution of each group may be approximated by a probability density function, and the approximated probability density functions may be compared with each other.

Further, the generation method of the comparison pair described in the second embodiment is merely an example, and other generation methods may be used as long as the object and function of the invention are met. For example, instead of using a combination with the head substring data as a comparison pair, the substring data temporally adjacent to each other may be used as a comparison pair. In addition, for example, the feature amount may be calculated using a comparison pair between the substring data of the substring data set a and the substring data of another substring data set. In this case, probability distributions of four feature amounts such as a pair a & b, pair a & c, pair a & d, and pair a & e are calculated from a, b, c, d, and e of the first group.

### INDUSTRIAL APPLICABILITY

The data amount sufficiency determination device according to the present disclosure is suitable for use in, for example, a factory automation (FA) system of a factory or a power generation system of a power plant. More specifically, data such as torque, current, and voltage output from manufacturing equipment in a factory FA system and a sensor attached to the manufacturing equipment, data measured by equipment in a power plant (power station), or data such as current, voltage, pressure, and temperature output from a separately attached sensor are assumed as the data for which the data amount sufficiency determination device determines the sufficiency. In factories, products are often repeatedly manufactured, and data acquired at the time of manufacturing is assumed to be a periodic waveform or a waveform in which a specific pattern or patterns repeatedly appear even if the waveform is not a periodic waveform. Moreover, it is assumed that, in the power plant, processing of activation, operation, and stop is repeated as one cycle, and even during operation, the test operation is periodically performed, and a waveform pattern associated therewith appears.

### REFERENCE SIGNS LIST

100, 200, 300, 400, 500, 600: data amount sufficiency determination device, 110, 210, 310, 410, 510, 610: time series data management device, 120, 220, 320, 420, 520, 620: learning device, 1000, 2000, 3000, 4000, 5000, 6000: learning model generation system, 101, 201, 301, 401, 501, 601: time series data acquisition unit, 102, 202, 302, 402, 502, 602: data division unit, 103, 203, 303, 403, 503, 603: data set generation unit, 104, 204, 304, 404, 504, 604: feature amount calculation unit, 105, 205, 305, 405, 505, 605: probability distribution generation unit, 106, 206, 306, 406, 506, 606: determination unit, 111, 211, 311, 411, 511, 611: time series data collection unit, 112, 212, 312, 412, 512, 612: time series data storage unit, 121, 221, 321, 421, 521, 621: learning data acquisition unit, 122, 222, 322, 422, 522, 622: trained model generation unit

1. A data amount sufficiency determination device comprising:
processing circuitry configured to
acquire time series data;
divide the time series data into a plurality of pieces of substring data;
generate a plurality of substring data sets that are sets of the substring data;
calculate a feature amount of the substring data;
generate probability distribution of the feature amount for each of the substring data set; and
determine whether or not the probability distribution has converged.

2. The data amount sufficiency determination device according to claim 1, wherein the processing circuitry generates a second substring data set by adding substring data not including a first substring data set to the first substring data set.

3. The data amount sufficiency determination device according to claim 1, wherein the processing circuitry generates a first substring data set and a second substring data set not including the substring data common to the first substring data set.

4. The data amount sufficiency determination device according to claim 3, wherein the processing circuitry generates the first substring data set and a third substring data set including at least one substring data included in the second substring data set.

5. The data amount sufficiency determination device according to claim 3, wherein the processing circuitry generates a first substring data set and a third substring data set not including substring data common to the second substring data set.

6. The data amount sufficiency determination device according to claim 1,
wherein the processing circuitry generates a first group having a plurality of the substring data sets and a second group having a same number of the substring data sets as the first group and having at least one substring data set not included in the first group,
the processing circuitry calculates a similarity between the probability distribution of the substring data set included in the first group and the probability distribution of the substring data set included in the second group, and
the processing circuitry determines that the probability distribution has converged in a case where the similarity has converged.

7. The data amount sufficiency determination device according to claim 1, wherein the processing circuitry calculates the feature amount for each of the substring data.

8. The data amount sufficiency determination device according to claim 1, wherein the processing circuitry calculates a comparison value between the first substring data and the second substring data as the feature amount.

9. The data amount sufficiency determination device according to claim 1,
wherein the processing circuitry generates a first set including the plurality of the substring data sets from the time series data included from a first time to a second time, and generates a second set including the plurality of the substring data sets from the time series data included from a third time to a fourth time, and
the processing circuitry determines that an amount of the time series data is sufficient in a case where a predetermined condition is met in both the first set and the second set.

10. A learning model generation system comprising:
processing circuitry configured to
acquires time series data;
divide the time series data into a plurality of pieces of substring data;
generate a plurality of substring data sets which are sets of the substring data;
calculate a feature amount of the substring data;
to generates probability distribution of the feature amount for each of the substring data sets;
determine whether or not the probability distribution has converged;
acquire the time series data as learning data in a case where it is determined that the probability distribution has converged; and
perform learning of a learning model using the learning data and generates a trained model.

11. A data amount sufficiency determination method comprising:
acquiring time series data;
dividing the time series data into a plurality of pieces of substring data;
generating a plurality of substring data sets that are sets of the substring data;
calculating a feature amount of the substring data;
generating probability distribution of the feature amount for each of the substring data sets; and
determining whether or not the probability distribution has converged.

12. A non-transitory computer readable medium with an executable program stored thereon, wherein the program instructs a computer to perform:
acquiring time series data;
dividing the time series data into a plurality of pieces of substring data;
generating a plurality of substring data sets that are sets of the substring data;
calculating a feature amount of the substring data;
generating probability distribution of the feature amount for each of the substring data sets; and
determining whether or not the probability distribution has converged.

13. A trained model generation method comprising:
acquiring time series data;
dividing the time series data into a plurality of pieces of substring data;
generating a plurality of substring data sets which are sets of the substring data;
calculating a feature amount of the substring data;
generating probability distribution of the feature amount for each of the substring data sets;
determining whether or not the probability distribution has converged;
acquiring the time series data as learning data in a case where it is determined that the probability distribution has converged in the determination step; and
performing learning of a learning model using the learning data and generate a trained model.

14. A non-transitory computer readable medium with an executable program stored thereon, wherein the program instructs a computer to perform:
acquiring time series data;
dividing the time series data into a plurality of pieces of substring data;
generating a plurality of substring data sets which are sets of the substring data;
calculating a feature amount of the substring data;
generating probability distribution of the feature amount for each of the substring data sets;
determining whether or not the probability distribution has converged;
acquiring the time series data as learning data in a case where it is determined that the probability distribution has converged in the determination step; and
performing learning of a learning model using the learning data and generate a trained model.
